(19) United States
(12) Patent Application Publication
(10) Pub. No.: US 2011/0291330 A1
(43) Pub. Date: Dec. 1, 2011

(54) REPLICATION METHOD AND ARTICLES OF THE METHOD

(76) Inventors: Mircea Despa, Horseheads, NY (US); Jennifer Lynn Lyon, Painted Post, NY (US); Paul John Shustack, Elmira, NY (US); Kevin Andrew Vasilakos, Corning, NY (US)

(21) Appl. No.: 13/075,289

(22) Filed: Mar. 30, 2011

Related U.S. Application Data
(60) Provisional application No. 61/349,066, filed on May 27, 2010.

(51) Int. Cl. B29C 59/16; B29C 59/00

(52) U.S. Cl. 264/447; 264/129

(57) ABSTRACT

A lamination or replication method for making an article having a structured solid layer, including:
dispensing a curable liquid onto a first member;
contacting the curable liquid on the first member with a complimentary second member having a curvature aspect, to form an assembly having the curable liquid disposed between the first and second members; and
curing the curable liquid to form the article, the structure being imparted by at least one of the first and second members. A display system that incorporates the article, as defined herein, is also disclosed.

### CLAIMING BENEFIT OF PRIOR FILED U.S. APPLICATION

This application claims the benefit of U.S. Provisional Application No. 61/349,066, filed on May 27, 2010. The content of this document and the entire disclosure of any publication, patent, or patent documents mentioned herein are incorporated by reference.

The entire disclosure of any publication, patent, or patent document mentioned herein is incorporated by reference.

### BACKGROUND

The disclosure generally relates to a method and apparatus for micro-replication using a curable liquid and articles of the method.

### SUMMARY

The disclosure provides a method and apparatus for micro-replication using a curable liquid, and articles of the method.

### BRIEF DESCRIPTION OF THE DRAWING(S)

In embodiments of the disclosure:

FIG. 1 is a schematic showing the relative positioning and motion between a draped flexible web and a flat tool, and the resulting interaction with the deposited curable liquid.

FIG. 2 is a schematic showing the relative positioning and motion between a draped flexible tool and a rigid, flat substrate, and the resulting interaction with the deposited curable liquid.

FIG. 3 shows a schematic of a roll-to-roll apparatus used for continuous or semi-continuous processing where a flexible web is controllably draped onto the surface of the curable liquid and the flat tool.

FIG. 4A-4D shows resonant peak properties detected for four different gratings prepared in accordance with the disclosed methods.

FIG. 5 shows an atomic force microscope (AFM) trace demonstrating the replication fidelity of the disclosed method.

### DETAILED DESCRIPTION

Various embodiments of the disclosure will be described in detail with reference to drawings, if any. Reference to various embodiments does not limit the scope of the invention, which is limited only by the scope of the claims attached hereto. Additionally, any examples set forth in this specification are not limiting and merely set forth some of the many possible embodiments of the claimed invention.

### DEFINITIONS

“Curable liquid” or like terms refer to any substance which can be conveniently dispensed and subsequently transformed so as to solidify the substance into a non-liquid, non-pourable, or like non-dispensable state, such as when treated with heat or radiation.

“Structured” or like terms refer to an article having discrete differences in the surface texture, such as having, for example, grooves, bumps, vias, troughs, pillars, and like 2D or 3D presentations on the surface, and which structure is other than a smooth or uniform surface coating.

“Replication,” “replicate,” or like terms refer to reproducing or making a copy or copies of an original or a master; the copy can be, for example, identical to an original master or template, or can be, for example, a negative or positive impression or a copy of the original master or template.

“Curvature aspect,” “curvature,” or like terms refer to an object having at least one surface portion having a curvilinear shape and that shape is sufficient to maintain an advancing contact front of curable liquid that is substantially free of entrapped gas pockets.

“AGM” or like term or abbreviation refers to “acrylate grating material,” which is an example of a curable liquid.

“Include,” “includes,” or like terms means encompassing but not limited to, that is, inclusive and not exclusive.

“About” modifying, for example, the quantity of an ingredient in a composition, concentrations, volumes, process temperature, process time, yields, flow rates, pressures, and like values, and ranges thereof, employed in describing the embodiments of the disclosure, refers to variation in the numerical quantity that can occur, for example: through typical measuring and handling procedures used for making compounds, compositions, composites, concentrates, or use formulations; through inadvertent error in these procedures; through differences in the manufacture, source, or purity of starting materials or ingredients used to carry out the methods; and like considerations. The term “about” also encompasses amounts that differ due to aging of a composition or formulation with a particular initial concentration or mixture, and amounts that differ due to mixing or processing a composition or formulation with a particular initial concentration or mixture. The claims appended hereto include equivalents of these “about” quantities.

“Consisting essentially of” in embodiments refers, for example, an article replication method, a replication method for making an article having discrete surface structure, articles made by the method, a surface lamination method, a method for an optical waveguide, or any apparatus of the disclosure, and can include the components or steps listed in the claim, plus other components or steps that do not materially affect the basic and novel properties of the compositions, articles, apparatus, or methods of making and use of the disclosure, such as particular reactants, particular additives or ingredients, a particular agents, a particular surface modifier or condition, or like structure, material, or process variable selected. Items that may materially affect the basic properties of the components or steps of the disclosure or that may impart undesirable characteristics to the present disclosure include, for example, a structured surface having defects or like imperfections, the use of excessive pressure during the contacting or patterning of the curable liquid, the use of a complex mechanism or movement during the contacting or patterning of the curable liquid, or a combination thereof, that are beyond the scope of the disclosure, including intermediate values and ranges, defined and specified herein.

The indefinite article “a” or “an” and its corresponding definite article “the” as used herein means at least one, or one or more, unless specified otherwise.

Abbreviations, which are well known to one of ordinary skill in the art, may be used (e.g., “h” or “hr” for hour or hours, “g” or “gm” for gram(s), “mL” for milliliters, and “rt” for room temperature, “nm” for nanometers, and like abbreviations).

Specific and preferred values disclosed for components, ingredients, additives, and like aspects, and ranges thereof, are for illustration only; they do not exclude other defined values or other values within defined ranges. The compositions, apparatus, and methods of the disclosure can include any value or any combination of the values, specific values, more specific values, and preferred values described herein.

Replication generally refers to a technique where contact is made between a patterned tool and a material, and where a pattern is transferred from the patterned tool to the material. UV replication can further refer to a technique where contact is made between a patterned tool and a material, such as a UV curable liquid, and where a pattern is transferred from the patterned tool to the material. The tool can bear the negative image of the desired relief pattern. Prior to replication, the liquid can be dispensed onto and supported by a substrate. The supporting substrate can optionally be integrated into the replicated finished part, such as in a lamination operation, or the supporting substrate can be separated for the finished part.

Replication of micron or sub-micron features is known. For example, replication using curable liquids has been practiced for making diffractive gratings, micro-lens arrays, waveguides, and like light management devices. The optical performance of such replicated parts can depend on the quality of the cured liquid. When the replicated part contains continuous films that transmit an optical signal, the thickness uniformity can be a significant consideration for the performance of the device. For example, diffractive gratings used in light transmission, such as the Epic® sensor (Corning, Inc.; www.corning.com), can rely on a uniform optical path through the patterned film to provide accurate spectral information. The interaction between the properties of the UV material and the fabrication method used for replicating these films determines the final thickness and refractive index uniformity, i.e., uniformity of the optical path.

Liquids that easily wet a surface can be used between the flat, rigid tool and the substrate surface in a replication operation called casting. When UV radiation is used, the process is referred to as UV cast-and-cure (UVCC). In this instance, the curable liquid can be dispensed and spread over the entire surface of the substrate (or tool) using a known coating technique, such as spin-coating or doctoring, or like deposition method. Alternately, the liquid can be dispensed in a predetermined pattern using a printing step. When the surface of the tool (or alternatively the substrate, if the dispensing was first accomplished onto the tool) is brought towards the liquid, contact with the liquid is made, and the curable liquid spreads outwards to the edges or the perimeter of the object being coated or replicated. When the tool contacts the curable liquid capillary action can often be sufficient to drive the liquid to fill the entire volume between the face of the tool and the face of the substrate. To speed up the spreading of the curable liquid pressure can be applied to the system. For example, U.S. Pat. No. 6,482,742, mentions a technique for replicating using an isostatic method of applying pressure to the tool and substrate.

However, the choice of the liquid, substrate, and tool materials is often based on their optical, mechanical, and chemical properties, and not their wetting characteristics. This can result in situations where a liquid that otherwise possesses the desired properties has to be cured between a tool and a substrate that may not wet well. These liquids can have very high contact angles on the tool surface, the substrate surface, or both. If such liquids are used in a UVCC operation, air entrapment can be a common issue. This can be attributable to the propensity of the liquid film to break apart and to form isolated islands upon dispensing onto the substrate; the islands may entrap air as the islands are forced towards one another under pressure. To avoid this entrap air condition, the patterning can be done using a curved tool surface and a flat substrate, a flat tool surface and a curved substrate, or both a curved tool and a substrate. In these instances, the curvature allows for the non-wetting liquid to contact the tool and subsequently advance in a predetermined fashion: first, a line of contact is established thus avoiding the possibility of air entrapment. This is because air can freely escape in front of or behind the contact line when the individual islands of non-wetting liquid are forced together. Second, as the curved surface is rolled forward, the contact line is also advancing in front, allowing for the air to escape in front of the contact line. U.S. Pat. No. 7,306,827 ('827 patent) mentions a method and apparatus for performing a roll-to-roll type of UV patterning, using a shuttle mounted pressure roll to drive the spreading of the UV liquid between the tool and the substrate. In the '827 patent the pressure roll drives the liquid to fully spread, and to expel air pockets that may be trapped. However, the use of a pressure roll makes contact with the substrate film. This contact can be a significant limitation of that method especially when films of pristine quality are desired. To make the highest quality optical films, it is desirable to avoid contacting the back side of substrate in any way, since, for example, any imperfections in the surface of the roll may cause the replication to fail in that area. In addition, debris trapped between the roll and the tool could damage the tool when the pressure roll passes over it. Alternately, if debris is caught between the roll and the substrate, the applied pressure can damage the back of the substrate and potentially introduce a defect.

In embodiments of the present disclosure at least the aforementioned shortcomings are overcome.

In embodiments, the disclosure provides a replication method for making an article, such as having two- or three-dimensional (2D or 3D) solid (non-liquid) structure, comprising:

dispensing a curable liquid onto a first member (e.g., a patterned tool or a substrate web);

contacting the curable liquid on the first member with a complimentary second member having a curvature aspect, to form an assembly having the curable liquid disposed between the first and second members (i.e., the tool and the web); and

curing the curable liquid to form an article having a structured solid layer, such as a transparent layer.

The method can further include, for example, separating the structured transparent solid layer from the one or both of the first member and second member.

The contacting can include, for example, draping the second member comprising a flexible substrate web onto the surface of the curable liquid and the first member comprising a flat tool. Alternatively, the contacting can include, for example, draping the second member comprising a flexible tool onto the surface of the curable liquid and the second member comprising a flat substrate web.

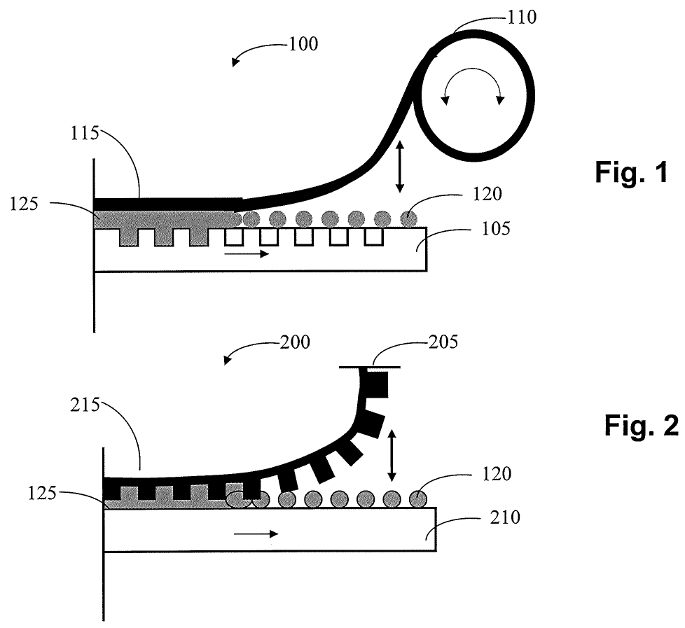

In embodiments, the curvature aspect can be, for example, sufficient to maintain an advancing contact front of curable liquid that is substantially free of entrapped gas pockets (see the left-to-right arrow in FIG. 1 (105) and FIG. 2 (210)).

In embodiments, the curing of the curable liquid can be, for example, accomplished by actinic radiation, e-beam, heat, and like methods, or a combination thereof.

In embodiments, dispensing the curable liquid can be, for example, accomplished by spray-coating, printing such as ink-jet, gravure, off-set, and like printing methods, slot-coating, roll-coating, spin-coating, and like methods, or a combination thereof.

In embodiments, the curable liquid comprises, can be, for example, an actinic radiation or electron beam curable composition suitable for use in replicating optical components, such as a monomer or monomer mixture comprised of:

a first diacrylate monomer of the formula:

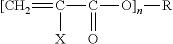

wherein

n is 2;

X is a hydrogen or a methyl group;

R includes at least one divalent alicyclic ring structure;

a second diacrylate monomer consisting of a neopentyl glycol propoxylated diacrylate monomer; and the composition being substantially free of monofunctional acrylates, such as having less than or equal to greater than 0% by weight to 5% by weight of urethane(meth)acrylates, halogenated (meth)acrylates, or monofunctional (meth)acrylates. The curable composition can further comprise at least one photoinitiator. The R in the curable liquid composition can be, for example, a bi-cyclic compound. The first monomer can be selected, for example, from the group of: 1,4-cyclohexane dimethanol di(meth)acrylate, hydrogenated bisphenol A di(meth)acrylate, tricyclodecane dimethanol di(meth)acrylate, tricyclodecane dimethanol diacrylate of the formula:

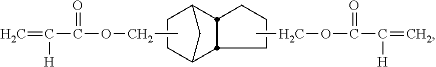

di(meth)acrylate of hydroxyl pivalaldehyde modified trimethylolpropane, limonene alcohol di(meth)acrylate, or a mixture thereof, and the neopentyl glycol propoxylated diacrylate monomer can be of the formula:

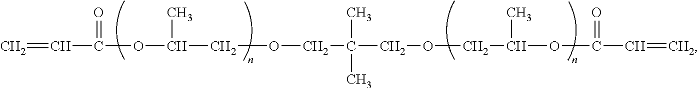

where n is an integer of 0 to 3, or a mixture thereof.

In embodiments, the curable liquid can be, for example, a non-wetting liquid. A non-wetting liquid can be any liquid having a contact angle greater than about 90 degrees and having a curable aspect. In embodiments, the curable liquid can be, for example, a wetting liquid. A wetting liquid can be any liquid having a contact angle less than about 90 degrees and having a curable aspect. In embodiments, the curable liquid can be, for example, a combination of a wetting liquid and a non-wetting liquid in a weight amount of from about 10 to about 90 weight percent to about 90 to about 10 weight percent.

In embodiments, the article can be any topologically enhanced surface, for example, a waveguide, a grating, an array of micron or submicron elements, a modified glass, and like forms, or combinations thereof.

In embodiments, the solid or transparent solid layer can have, for example, a thickness of from about 100 nm to about 250 microns. In embodiments, the solid or transparent solid layer can have, for example, a thickness of from about 1 nm to about 500 nm.

In embodiments, the disclosure provides a process for producing a polymer optical waveguide comprising:

applying a curable resin layer on a template;

combining the curable liquid on the template and a substrate film to form an assembly having the curable liquid disposed between the template and a substrate film;

curing the curable liquid to a solid (e.g., a transparent piece part); and

separating the template from the assembly having the solid; and optionally separating the substrate film from the solid, and where the template, the substrate film, or both, have a curvature.

In embodiments, the disclosure provides a method for laminating a surface, comprising:

fixing a substrate web in proximity to a tool (e.g., the continuous substrate is pinched by an adjustable pinch member, or like temporary holding means such as a vacuum manifold or vacuum plenum (not shown) situated in the area about where the draping contact is accomplished and beyond, such as at the perimeter of the web or tool, and which area is not being imprinted);

tensioning the fixed substrate to a first open (taut) position;

dispensing a curable liquid onto the tool to form a contact line wherein the contact line can be, for example, a bead, a droplet, an island, a worm, a line, and like dispositions, or combinations thereof, of the curable liquid; and

de-tensioning the fixed substrate to a second closed (slackened) position.

The de-tensioning of the fixed (pinched) substrate to a second closed (slackened) position can be, for example, accomplished in a controlled manner to maintain an advancing front (e.g., doctor or plow pattern) or contact line between the tool, the curable liquid material, and the substrate web. The de-tensioning results in gently draping the substrate web onto the tool member having an intermediate layer of the curable liquid sandwiched between the web and the tool. Draping the substrate web onto the curable liquid on the tool causes the liquid to advance in the same direction as the advancing drape by, for example, capillarity, positive displacement, or both.

In embodiments, the method for laminating a surface can further comprise re-tensioning the fixed or pinched substrate web to the first open or taut position and thereafter releasing the fixed substrate web. In embodiments, the method for laminating a surface can be selected when laminating flexible films onto planar substrates, such as glass, plastic, or materials.

In embodiments, the disclosure provides an article replication method, comprising:

dispensing a curable liquid onto a patterned tool;

contacting the curable liquid on the patterned tool with a substrate web to form an assembly comprising the tool and the substrate web having the curable liquid disposed between the tool and the substrate web; and

curing the curable liquid to form a solid layer, wherein the patterned tool, the substrate film, or both, have a curvature aspect.

The replication method can further include separating the patterned tool from the assembly having the solid.

In embodiments, the disclosure provides an article replication method, comprising: repeating the aforementioned process steps, at least one time, and one or more times, such as two to about 10 times, or more, to provide an article having two or more cured layers. The cured layers can have, for example, the same or different cured material, the same or different structural aspects such as the same or different grating or like replicated pattern(s) (that is a change of tool or substrate) or feature(s) for preparing, for example, various 1D, 2D, or 3D structures, and like material or process variation, or combinations thereof.

In embodiments, the disclosure provides a method and an apparatus for performing UV replication using a non-wetting liquid. The method can be accomplished without contacting the backside of a flexible substrate or tool. The method uses the controlled motion of a curved surface (substrate film or tool) relative to a flat surface (tool or substrate) to replicate a pattern without the risk of damaging the tool or producing defects on the backside of the substrate. A roll-to-roll operation can optionally be use to accomplish the method in a continuous or semi-continuous fashion and to produce high quality replicas of the tool pattern.

In embodiments, the disclosure provides a method and apparatus for micro-replication using UV curable liquids.

In embodiments, the disclosure provides a method and an apparatus as defined herein having particularly significant aspects that can include, for example:

elimination of damage to the substrate and to the tool;

improved uniformity of the cured film thickness;

a simple design having lower machine and manufacture costs; and

a roll-to-roll apparatus and process suitable for applications such as gratings, anti-splinter glass compositions, protective glass coatings, and like imprint or coating applications.

In embodiments, the initial film thickness, that is the curable liquid prior to curing, can have a variation of, for example, from about 1 micrometer to about 10 micrometers. In embodiments, the final cured film thickness variation can be, for example, from about plus or minus about 100 nm to about 1 micrometers.

Suitable curable liquids can include, for example, polymer precursors such as monomers, oligomers, and mixtures thereof, or a liquid polymer that can be further cured or cross-linked to a solid. Example polymers can include, for example, acrylate polymers or copolymers (i.e., having two or more different monomers) or having monomers such as acrylic acid, methacrylic acid, or one of their esters, and like monomers, or combinations thereof, and salts thereof. Other polymers and copolymers of acrylic acid and salts thereof, such as sodium, calcium, magnesium, zinc, ammonium and like ions, and another monomer can include, for example, ammonium acrylate copolymer, ammonium vinyl alcohol (va) acrylate copolymer, sodium acrylate copolymer, ethylene acrylic acid copolymer, ethylene acrylate copolymer, ethylene acrylic acid-va copolymer, acrylate vinyl pyridine (vp) copolymer, acrylate-va copolymer, steareth-10 allyl ether acrylate copolymer, acrylate steareth-50 acrylate copolymer, acrylate steareth-20 methacrylate copolymer, acrylate ammonium methacrylate copolymer, styrene acrylate copolymer, styrene acrylate ammonium methacrylate copolymer, ammonium styrene acrylate copolymer, sodium styrene acrylate copolymer, acrylate hydroxyester acrylate copolymer, methacryloyl ethyl betaine acrylate copolymer, lauryl acrylate-va copolymer, va-butyl maleate isobornyl acrylate copolymer, ethylene methacrylate copolymer, vinyl caprolactam-vp dimethylaminoethyl methacrylate copolymer, sodium acrylate acrolein copolymer, vp-dimethylaminoethylmethacrylate copolymer, and like copolymers, and mixtures thereof. Polymers of acrylic acid and salts thereof can be, for example, polyacrylic acid, ammonium polyacrylate, potassium aluminum polyacrylate, potassium polyacrylate, sodium polyacrylate, and like polymers, and mixtures thereof including mixtures with copolymers or another film former. The curable liquid can include various performance additives, such as a colorant, a pigment, an antioxidant, a surfactant, and like materials, or combinations thereof, that can improve the performance or behavior of the curable liquid or in resulting cured solid.

In embodiments, the article can be an opaque, translucent, transparent, semi-transparent, or combinations thereof of a glass or plastic sheet, or like materials, such as those used as base plates for standardized microplates, cover plates, culture vessels, and for display windows and touch screen applications, for example, portable communication and entertainment devices such as telephones, music players, video players, or like devices; and as display screens for information-related terminal (IT) (e.g., portable or laptop computers) devices; and like applications. The glass article or substrate can have a thickness of up to about 3 millimeters (mm). In embodiments, the glass article or substrate thickness can be from about 0.2 to about 3 mm. In embodiments, the glass article can have at least one surface that is unpolished. In embodiments, the method of making can further include the optional step of conditioning the surface of the article or substrate using an additional preparative, pre-treatment or post-treatment procedure, for example, removing oil, foreign matter, or other debris that may interfere with the intended use application using methods known in the art, including, for example, washing with soaps or detergents, ultrasonic cleaning, treatment with surfactants, and like methods.

In embodiments, the disclosure provides a display system. The display system can include at least one glass or plastic panel and optionally a pixelated image-display panel adjacent to the glass or plastic panel. The image-display panel can have a minimum native pixel pitch dimension. The pixelated image display panel can be, for example, one of an LCD display, an OLED display, or like display devices. The display system can also include touch-sensitive elements or surfaces. The glass can be ion-exchanged and can have at least one roughened surface comprising a plurality of features.

In embodiments, the disclosure provides a method for performing UV replication without making direct contact with the back side of the substrate. A flat tool can be used in combination with a flexible film substrate. Alternately, a flexible tool can be used in conjunction with a flat, rigid substrate. In embodiments, the method can be accomplished by contacting a curable liquid with, for example, a curved tool, a curved substrate web, or a combination thereof. In embodiments, contacting the curable liquid can be accomplished with no additional external pressure application or equipment, such as from the weight of the tool, the substrate web, or a combination thereof, depending upon the contacting configuration selected.

### EXAMPLES

The following examples serve to more fully describe the manner of using the above-described disclosure, and to further set forth the best modes contemplated for carrying out various aspects of the disclosure. It is understood that these examples do not limit the scope of this disclosure, but rather are presented for illustrative purposes. The working examples further describe how the methods and to of the disclosure.

### Example 1

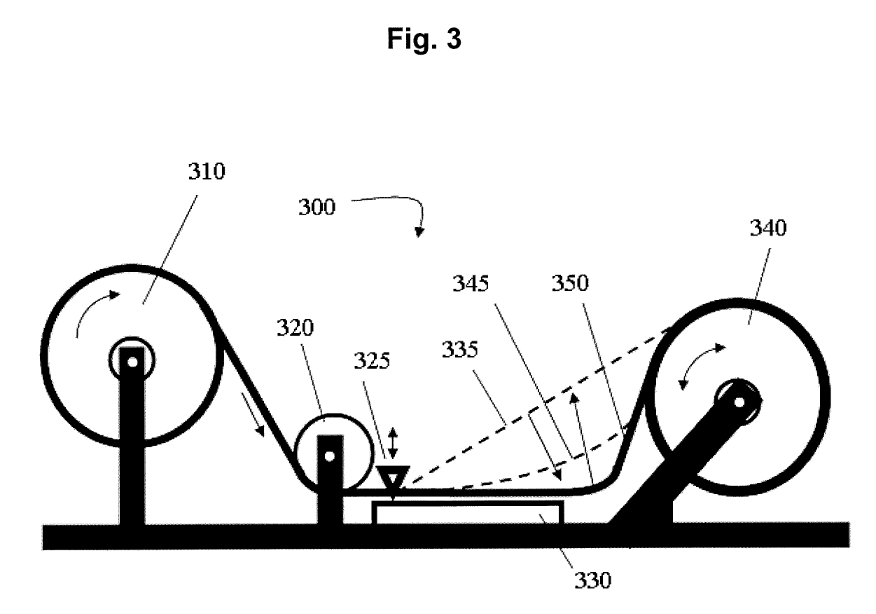

An example of an exemplary setup includes having a flat quartz mask (6″ square, 0.25″ thick) tool with a flexible film drape. Referring to the Figures, the tool (330) can include, for example, a pattern of interest on one side and facing upwards in the apparatus as shown in FIG. 3. A flexible film drape, for example, about 5 mil thick polystyrene was used as a substrate for the final device. The UV curable liquid was dispensed onto the tool. The film was precisely laid onto one end of the tool, while unraveling or unrolling the film from its carrier roll. The unraveling can shape the film with a given radius-of-curvature. This can be achieved by a rolling motion; the film comes into contact with the curable liquid along a contact line, which line progresses from one end of the tool to the opposite end. To control the relative angle between the film and the tool, the film roll is translated in the horizontal direction, downward direction, or both directions, in addition to the rotational motion. FIG. 1 shows a schematic diagram of this setup where the relative positioning and motion between a draped flexible web (115) and a flat tool (105), and the resulting interaction with the deposited curable liquid before contacting (120) and after contacting (125) with the flexible web (115). FIG. 2 shows a similar setup, but where the componentry is reversed, that is, where the tool (215) is flexible and is used as the drape, and the rigid substrate (210) is kept flat. For instance, a flexible silicone tool (215) can be used in conjunction with a rigid, flat substrate, such as an LCD glass sheet. Irradiation and curing can be accomplished, for example, through an UV transparent substrate, through a UV transparent tool, or both.

Such a setup allows for the replication to occur without the drawbacks introduced when using a pressure roller that forces the tool and the film together by directly contacting the back side of the film. In embodiments of the inventive setup, the film is carefully laid onto the UV curable liquid and the contact line is advanced by the motion of the roll. Any air entrapment is avoided because air is constantly displaced in front of the advancing contact line. If debris is trapped between the tool and the substrate, there is no load (other than the very low weight of the film) to drive the debris into the tool, thus there is no risk of damaging the tool. If debris exists onto the back side of the film, there is no load that would impress the debris into the film, because no pressure roll is used in this setup. The absence of the pressure roll also eliminates the chance to introduce defects or to damage the tool if the pressure roll would become damaged with burrs or other type of protruding surfaces. Lastly, no load gradients exist that otherwise would be present if a pressure roll was used.

After curing, the flexible film or tool can be removed in a motion similar to the lay-down deposition step, to effectively peel either or both the flexible film or tool off in a controlled motion.

### Example 2

Replication using a rigid flat tool and a flexible film. A rigid flat tool was used while bending the flexible film substrate. In this approach, the tooling solution is greatly simplified, so that one can use glass or silicon wafers patterned for instance by lithographic methods. Such tooling is robust and can withstand theoretically unlimited exposure to UV radiation. In this approach, the tool is laid down with the gratings (i.e., the pattern to be replicated) facing up, and the film is brought into contact with the tool by generating a line of contact at the trailing end, similar to when using a silicone tool. The leading edge of the film is then slowly lowered flat, thus advancing the line of contact in that direction. UV curing was performed through the transparent substrate.

### Example 3

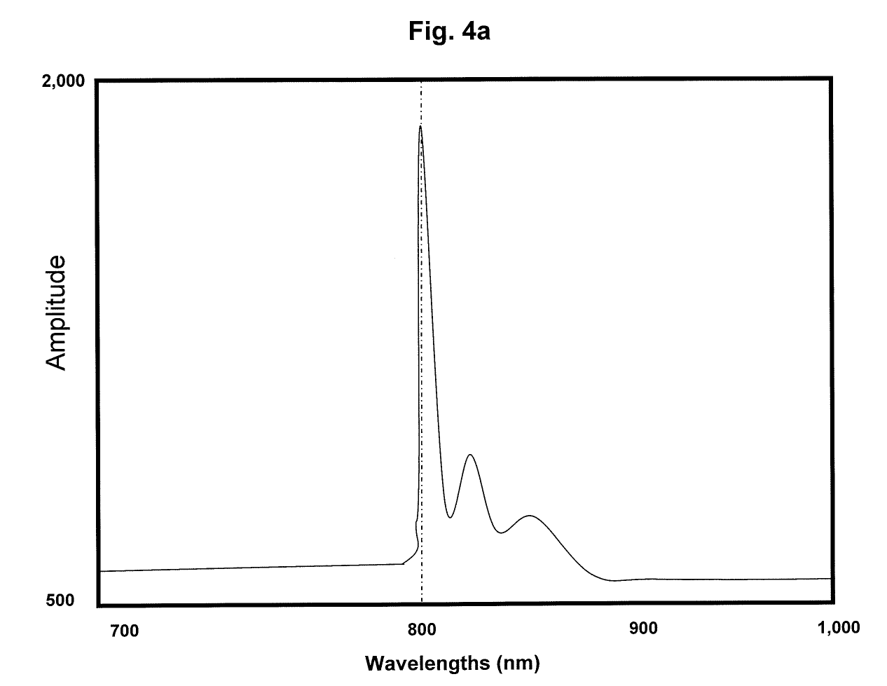

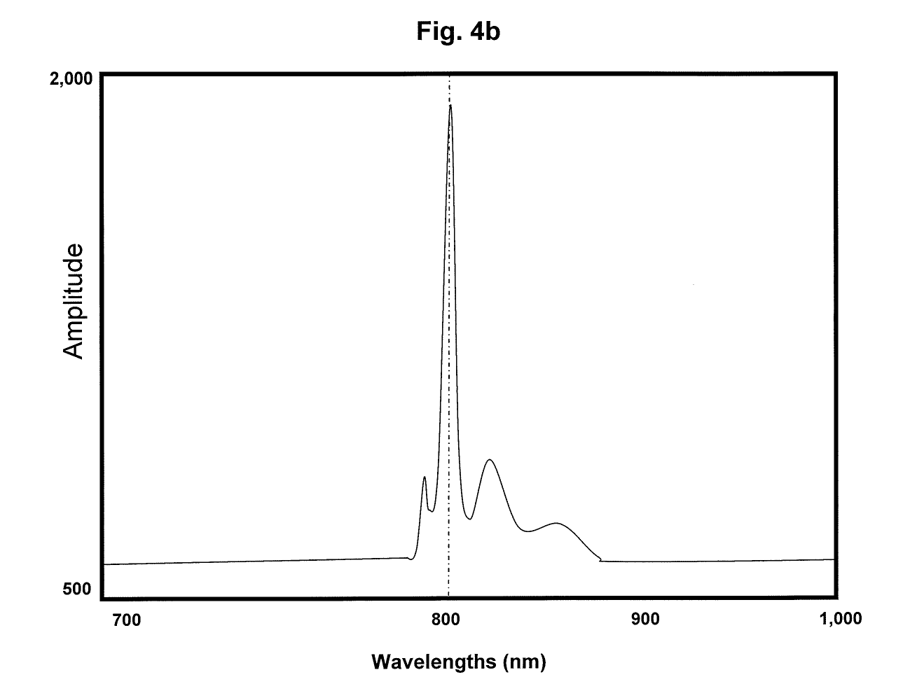

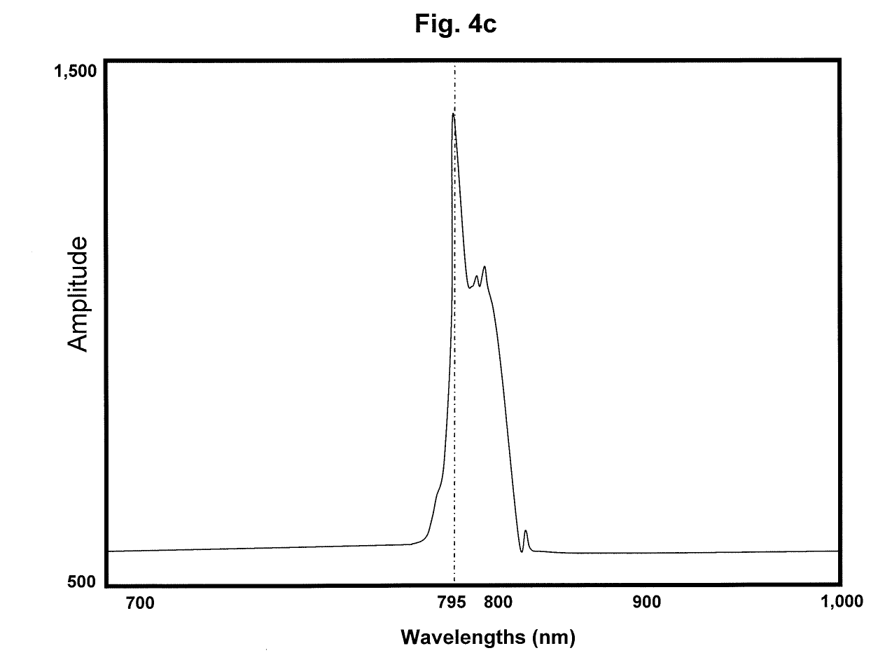

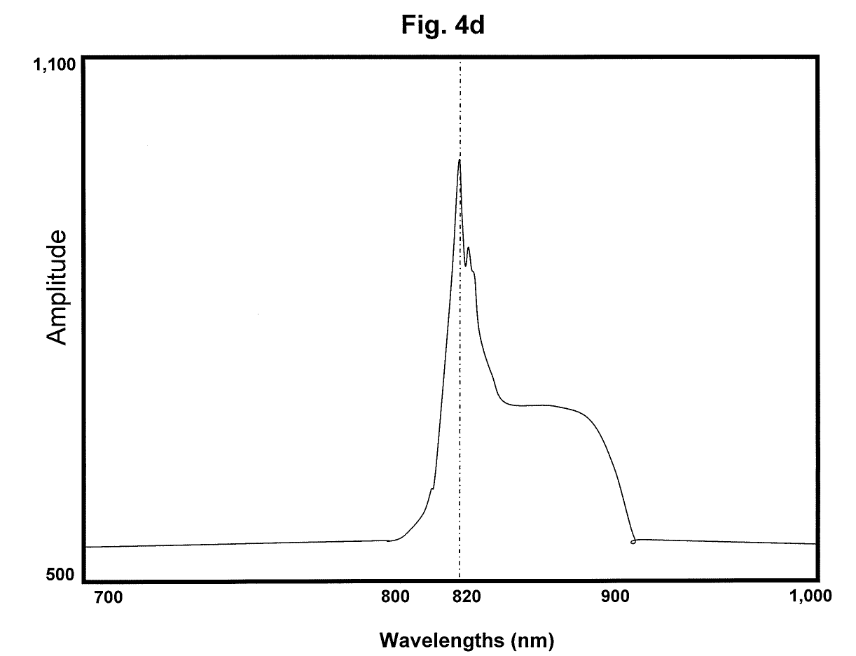

Replication using a rigid tool. The line-of-contact was established by draping or bending the substrate upon the rigid tool and fixing the relative origin and position by pinching with the pincher or seating with a vacuum assist. The UV active liquid was dispensed, for example, either onto the tool or onto the flexible film surface. Grating-based resonant sensors were fabricated in this fashion, using a UV curable formulation that exhibited a high contact angle on both the tool and the substrate material. A 384-grating pattern was replicated, and four sensors were randomly scanned. The sensors were then interrogated using a broad wavelength laser source. A resonant signal was detected at around 800 nm, as shown in FIG. 4. FIG. 4 shows resonant peak properties (amplitude v. time in seconds) detected for four different gratings prepared in accordance with the disclosure (FIG. 4A: L13; FIG. 4B: B10; FIG. 4C: H5; FIG. 4D: D13, where the letter-number designation corresponds to the standard SBS 384-well address scheme for Rows A to P, and columns 1 to 24).

The disclosed replication methods can be used in low-cost grating fabrication, such as for production of the Corning, Inc., Epic® biosensor, among many other applications for mass-producing roll-to-roll micro-patterns of various geometries.

Another application of the disclosed replication method, in addition to imprinting, is laminating flexible films onto glass or plastic planar substrates. After laminating, the glass or plastic planar substrate can bear just the cured layer or it can bear both the cured layer and the flexible substrate film. The imprint tool can be replaced by the glass to be coated, and the process can be carried out in the same fashion as when imprinting, except that measures are taken such that the UV coating adheres solidly to the glass, after cure. If the glass is to be coated with the cured material only, the substrate film can be selected to be a non-stick type (e.g., fluorinated material) and, after lay-down and UV cure, the substrate film was cleanly peeled off, leaving behind the glass coated with the cured material. If the glass is laminated with both the cured layer and the substrate film, then the latter is selected to be adherent to the cured material, and is left in place after cure. For example, in an experiment comparable to imprinting gratings into AGM, the roll-to-roll unit was used to cover a glass piece with a PET film, using AGM as an adhesion layer. Alternately, a fluorinated ethylene-propylene (FEP) film was used over a UV curable formulation. In this last case, the FEP film was peeled off the UV cured material at the end of the process. These experiments illustrate and demonstrate the potential for the disclosed method and apparatus to be used for depositing and planarizing a layer of UV curable material onto glass, with a cover film present or absent at the end of the process.

In embodiments, the cured layer or cured transparent film can have a range of thicknesses, such as from about 1 to about 500 nm, from about 1 to about 250 nm, from about 10 to about 250 nm, from about 10 to about 100 nm, and from about 20 to about 100 nm, including intermediate values and ranges, and can be imprinted into or coated onto glass. When coating glass with the curable liquid in the above mentioned examples, the resulting cured layer thickness could be selected as needed, for example, from about 20 to about 100 microns. The volume of curable liquid needed to cover a given area and having a desired thickness can be calculated prior to dispensing the curable liquid. When using the disclosed system for imprinting gratings using a curable liquid of a monomer or a polymer, the cured layer was, for example, less than about 1 micrometer thick. For thicker cured layers, gratings could be cast, for example, onto a polyethylene terephthalate (PET) film using, for example, an acrylate-based UV formulation (for additional details see commonly owned and assigned U.S. Patent Application Publication 20080269448 to Shustack, P. J., et al., entitled “Photo or Electron Beam Curable Compositions,” filed Nov. 30, 2005). The thermal, photo, or electron-beam curable composition can have a low viscosity (e.g., less than or equal to about 500 cPs) and cures to an optically clear material having a high glass transition temperature (e.g., greater than or equal to 70° C.), low shrinkage on cure, low out-gassing, and low extractables. The cured layer thickness averaged about 20 microns.

FIG. 3 shows a schematic of an exemplary roll-to-roll apparatus that can be used for continuous or semi-continuous processing where, for example, a flexible web can be draped onto the surface of the curable liquid and the flat tool. The roll-to-roll system (300) including a pay-out roll (310) for dispensing a web or film including an optional braking mechanism (not shown) to oppose tension when the film is advanced, an optional web height-adjust roller (320), a height-adjustable pinch bar (325) for holding the film fixed when laying down (draping) the web onto tool (330) and curable liquid (120) (not shown). The tool (330) can be, for example a wafer, mask substrate, or the like. A take-up roll (340) can include an optional motorized mechanism (not shown) to drive the take-up roll when the film is advanced for tensioning and when replicating. The tool (330) can be, for example, a wafer, mask substrate, or like objects that can impart desired structure to the curable liquid and cured liquid. In a first configuration the web (335) is in an “open” position by tension between the lowered pinch bar (325) and the take-up roll (340). While the web is in the open position the curable liquid can be deposited on the tool using any suitable dispensing method. Alternatively, the tool can be removed from the apparatus, the curable liquid can be deposited on the tool, and the tool inserted in its original position on the apparatus (300). Next, the take-up roll (340) can be gently reversed (counter clockwise) to remove some tension from the web (345) and to eventually drape the web into the “closed” or “down” position (350) and on the curable liquid and tool combination. While the web is in the lowered (“closed” or “down”) position (350) the combined tool, curable liquid, and web, can be irradiated, or like treatment with a suitable source (not shown), such as by directing radiation through the transparent web or transparent tool. After a brief residence time, such as from about several seconds to several minutes, the take-up roll can be retensioned to separate the web and the associated cured liquid, now a clear solid layer adhering to the web (i.e., web-solid layer), from the tool. The pinch bar (325) can be raised to separately or simultaneously release and advance the web-solid layer toward the take-up roll (340). The foregoing manipulations or sequence, or like variants, can be repeated ad infinitum manually or automatically (robotically) as desired until the pay-out roll is consumed or replenished.

This system can be assembled from readily available and inexpensive components. In embodiments, the system can be operated as follows. A roll of substrate film is placed at the pay-out roll (310) end and the lead end is fed under the pinch bar (325) and over the tool (330), then affixed to the take-up roll (340). The UV curable material can be dispensed onto the tool, for example, by precision jetting. The pinch bar is lowered and the film is fixed to the tool or substrate, i.e., the trailing end is pinned or kept stationary. The take-up roll is partially rotated counter-clockwise and the film is slowly lowered onto the tool, from the trail-end toward the lead-end. A contact line is formed and advanced in this fashion, as described above. When the film covers the entire area of the tool, the rotation is stopped and the curing energy source, such as a UV lamp (not shown) is activated to accomplish the cure. The energy can be delivered through a UV transparent substrate, through a UV transparent tool, or both. After curing, the take-up roll begins to turn clockwise to retension the film and release the film from the tool. Many different versions or variations of this system can be envisioned. Each is based on the same principle of controlled draping deposition of a flexible film against a flat tool surface or the converse, i.e., a flexible tool against a flat film.

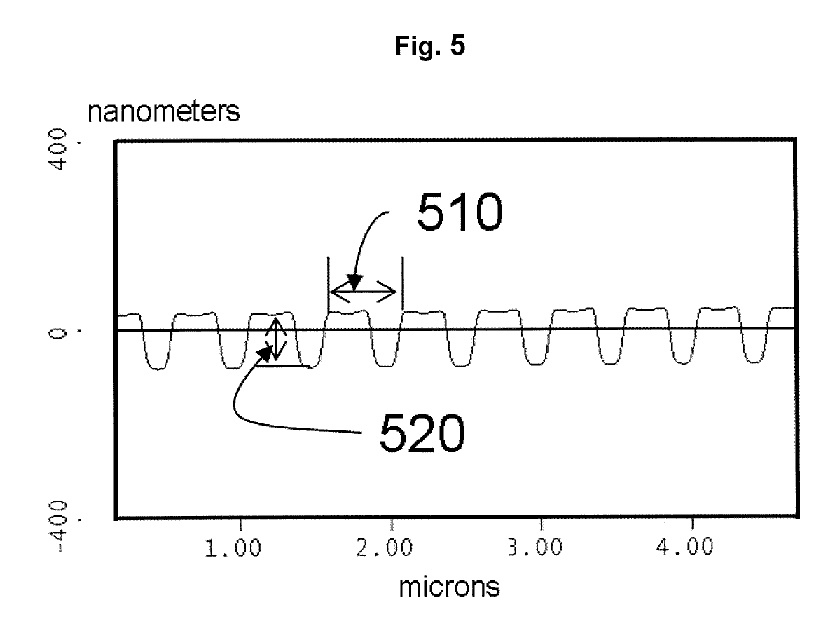

FIG. 5 shows an atomic force microscope (AFM) trace demonstrating the replication fidelity of the disclosed method. The AFM trace shows the results of a section analysis of a grating replicated (i.e., imprinted) into acrylate grating material (AGM), atop a PET film substrate, where an exemplary pitch (510) is about 500 nm and having a depth (520) of about 120 nm.

The results demonstrate that the disclosed system can be used to make a replicated article having a thickness of from sub-micron to tens of microns, including intermediate values and ranges. More specifically, coatings of from 100 nm up to 250 microns can be readily attained.

The disclosure has been described with reference to various specific embodiments and techniques. However, it should be understood that many variations and modifications are possible while remaining within the scope of the disclosure.

What is claimed is:

1. A replication method for making an article, comprising:
dispensing a curable liquid onto a first member;
contacting the curable liquid on the first member with a second member having a curvature aspect, to form an assembly having the curable liquid disposed between the first and second members; and
curing the curable liquid to form an article having a structured solid layer.

2. The method of claim 1 further comprising separating the structured solid layer from the one or both of the first member and second member.

3. The method of claim 1 wherein contacting comprises draping the second member comprising a substrate web onto the surface of the curable liquid and the first member comprising a flat tool.

4. The method of claim 1 wherein contacting comprises draping the second member comprising a flexible tool onto the surface of the curable liquid and the second member comprising a flat substrate web.

5. The method of claim 1 wherein the curvature aspect is sufficient to maintain an advancing contact front of curable liquid that is substantially free of entrapped gas pockets.

6. The method of claim 1 wherein curing the curable liquid is accomplished by actinic radiation, e-beam, heat, or a combination thereof.

7. The method of claim 1 wherein dispensing the curable liquid is accomplished by printing, spray-coating, slot-coating, roll-coating, or a combination thereof.

8. The method of claim 1 wherein the curable liquid comprises:
a single monomer or monomer mixture comprised of:
a first diacrylate monomer of the formula: 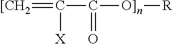
wherein
n is 2;
X is a hydrogen or a methyl group;
R includes at least one alicyclic ring structure; and
optionally a second diacrylate monomer consisting of a neopentyl glycol propoxylated diacrylate monomer, the composition being substantially free of mono functional acrylates.

9. The method of claim 1 wherein the curable liquid is a non-wetting liquid, a wetting liquid, or a combination thereof.

10. The method of claim 1 wherein the article is a waveguide, a grating, an array of micron or submicron elements, a surface modified glass, or combinations thereof.

11. The method of claim 1 wherein the solid layer has a thickness of from about 100 nm to about 250 microns.

12. The method of claim 1 wherein the solid layer has a thickness of from about 1 nm to about 500 nm.

13. A process for producing a polymer optical waveguide comprising:
applying a curable liquid on a template;
combining the curable liquid on the template and a substrate film to form an assembly having the curable liquid disposed between the template and a substrate film;
curing the curable liquid to a solid; and
separating the template from the assembly having the solid; and
optionally separating the substrate film from the solid, and wherein the template, the substrate film, or both, have a curvature.

14. A method for laminating a surface, comprising:
fixing a substrate web in proximity to a tool;
tensioning the fixed substrate to a first open position;
dispensing a curable liquid onto the tool to form a contact line; and
de-tensioning the fixed substrate to a second closed position.

15. The method of claim 14 further comprising re-tensioning the fixed substrate web to the first open position and thereafter releasing the fixed substrate web.

16. An article replication method, comprising:
dispensing a curable liquid onto a patterned tool;
contacting the curable liquid on the patterned tool with a substrate web to form an assembly comprising the tool and the substrate web having the curable liquid disposed between the tool and the substrate web; and
curing the curable liquid to form a solid layer, wherein the patterned tool, the substrate film, or both, have a curvature aspect.

17. The method of claim 16 further comprising separating the patterned tool from the assembly having the solid.

18. The method of claim 1 further comprising:
repeating, at least one time, the sequence of dispensing, contacting, and curing.

19. The method of claim 1 wherein the structured solid is transparent.

20. The method of claim 18 wherein the structured solid has at least two structured layers.
